(19) United States
(12) Patent Application Publication
(10) Pub. No.: US 2004/0024900 A1
(43) Pub. Date: Feb. 5, 2004

(54) Method and system for enhancing streaming operation in a distributed communication system

(75) Inventors: Gerd Breiter, Wildberg (DE); Frank Walter Kunze, Bietigheim-Bissingen (DE); Hendrik Wagner, Stuttgart (DE)

Correspondence Address: Leslie J. Payne,, IBM Corporation, Dept. 917, 3605 Highway 52 North, Rochester, MN, 55901-7829, US

(73) Assignee: INTERNATIONAL BUSINESS MACHINES CORPORATION, ARMONK, NY (US)

(21) Appl. No.: 10/616,526

(22) Filed: Jul. 10, 2003

(30) Foreign Application Priority Data
Jul. 30, 2002 (EP) 02102072.2

(51) Int. Cl. G06F 15/16; G06F 15/173

(52) U.S. Cl. 709/231; 709/225

(57) ABSTRACT

A method and system are provided for enhancing streaming operation in a distributed communication system providing communication links between a plurality of stream servers, a client machine requesting a particular media file, and, a stream server selection unit. First, a list of stream servers is retrieved. Then, the list is evaluated and one of the stream servers is selected as the best-suited stream server. Streaming from the selected stream server is initiated

### BACKGROUND OF THE INVENTION

1. Field of the Invention

The present invention relates to the field of data communication, in particular to distributing and streaming of data, for accessing digital information, including audio, video, and business type information, at remotely stored locations and for communicating that information to a user's premise. Particularly, the present invention relates to a method and system for enhancing streaming operation in a distributed communication system, such as the Internet.

2. Description of the Related Art

New media data extends traditional computer data formats into more natural data formats for the interaction of humans and computers by incorporating images, motion pictures, voice, audio and video. One of the key problems with new media data is transferring the usually huge amounts of content through a network. Using streaming technology, such as streaming video and streaming media, usually does this.

Streaming video is a sequence of “moving images” that are sent in compressed form over the Internet and displayed by the viewer as they arrive. Streaming media is streaming video with sound. With streaming video or streaming media, a Web user does not have to wait to download a large file before seeing the video or hearing the sound. Instead, the media is sent in a continuous stream and is played as it arrives. The user needs a player, which is a special program that uncompresses and sends video data to the display and audio data to speakers. A player either can be an integral part of a browser or downloaded from the software maker's Web site.

Major streaming video and streaming media technologies include RealSystem G2 from RealNetwork, Microsoft Windows, Media Technologies, IBM's Video charger/Video charger player, and Apple Computer's QuickTime The standard MPEG (Moving Picture Experts Group) compression algorithm may be used for video. Other approaches use proprietary algorithms. Present technology offers streaming audio at up to 96 Kbps and streaming video at up to 8 Mbps. However, for most Web users, the streaming video will be limited to the data rates of the connection, e.g., up to 128 Kbps with an ISDN connection.

Streaming video is usually sent from pre-recorded video files, but can be distributed as part of a live broadcast “feed.” In a live broadcast, the video signal is converted into a compressed digital signal and transmitted from a special Web server that is able to do multicast, i.e., sending the same file to multiple users at the same time.

A stream server normally requires all data to be streamed to reside locally on the stream server. The connection bandwidth to the rendering client, i.e., the media player, has to fulfill at least the requirements corresponding to the nature of the data to be transmitted. For this reason, stream servers are placed on so-called edge servers, i.e., the edge of the network in the connection path to the client, also referred to as the “last mile”.

In order to initiate a streaming operation streaming meta data needs to be provided to the rendering client requesting the stream. The meta data or meta file usually contains at least an identification (key) of the media data to be streamed and the identification of the stream server, e.g., the TCP/IP host name of the stream server machine and the port the stream server software listens to.

When a user wants to have media streamed to his client, he normally “clicks” on a hyperlink identifying the media on the web page presented to him through his web browser. The web browser generates an http request containing the media identification information. As a response to that, the application server sends the media meta data to the client's web browser. Based on that information, the web browser typically invokes the corresponding media player, which resides on a client and is responsible for receiving the meta data from the network, negotiating a connection to the stream server, and receiving/rendering the data in parallel.

The way streaming technology is realized today, media players are only able to render streams from a corresponding stream server usually built by the same company. U.S. Pat. No. 6,151,634 by Glaser et al., assigned to RealNetworks, Inc., Seattle, Wash. (US), filed Mar. 13, 1998, issued Nov. 21, 2000, “Audio-on-demand Communication System” describes a system for real-time playback of audio data transferred via telephone lines or other communication links. According to one embodiment, a subscriber PC continuously monitors the status of a buffer for temporarily storing the transferred audio data to determine whether or not the buffer is at or near maximum capacity. If yes, then the subscriber PC sends a high quality message to an audio control center. The high quality message indicates to the audio control center that it should transmit high quality data compressed according to a lossless compression algorithm. However, if it is determined that there is insufficient bandwidth to send high quality data, normal quality data may be transmitted instead as a substitute.

A common problem of the prior art data transfer protocols, in particular streaming protocols over a computer network, such as the Internet, is the bandwidth and other requirements, such as the availability of software or hardware equipment, needed to perform a streaming operation.

### OBJECT OF THE INVENTION

Starting from this, the object of the present invention is to provide a method and a system for enhancing streaming operation in a distributed communication system, such as the Internet.

### BRIEF SUMMARY OF THE INVENTION

According to the present invention a method and a system is provided for enhancing streaming operation in a distributed communication system providing communication links between a plurality of stream servers, a client machine requesting a particular media file. First, a list of stream servers is retrieved. Then, the list of stream servers is evaluated and one of the stream servers on said list is selected as being the best-suited stream server. Finally, streaming from said selected stream server is being initiated.

In a preferred embodiment of the present invention the list of stream servers is retrieved from a directory service, such as UDDI (Universal Description, Discovery, and Integration).

Advantageously, the stream server's capabilities and/or the media player availability and/or preferences provided by the client and/or the client connectivity situation are retrieved and considered during the evaluation of the list of stream servers.

In another preferred embodiment one or more of the considered parameters may be weighted during evaluation of the list of stream servers.

Furthermore, it may be determined whether the stream server can handle streaming of the requested media file and/or whether or not the format of the media has changed and/or whether or not the quality of the media is too high for the connection from the selected stream server to the client machine. In case the media format has changed, a format conversion may be performed and in case, the media quality is too high for the available connection.

In the same environment, but on the client machine the following method and device may be implemented. First, the data transfer rate between the client machine and the distributed communication system is detected. Then, a request for streaming a media file is intercepted and modified by appending preference information for streaming of the requested media file. Finally, the modified streaming request is sent to a stream server selection unit.

In a preferred embodiment the capabilities of the client machine is detected and/or preferences predetermined by the user of the client machine are retrieved.

The above, as well as additional objectives, features and advantages of the present invention, will be apparent in the following detailed written description.

### BRIEF DESCRIPTION OF THE DRAWINGS

The novel features of the invention are set forth in the appended claims. The invention itself, however, as well as a preferred mode of use, further objectives, and advantages thereof, will best be understood by reference to the following detailed description of an illustrative embodiment when read in conjunction with the accompanying drawings, wherein:

FIG. 1 illustrates a flow chart illustrating the procedure in accordance with the present invention performed on the client machine;

FIG. 2 illustrates a block diagram illustrating the influencing factors on the stream server selection process in accordance to the present invention;

FIG. 3 illustrates a flow chart illustrating the procedure in accordance with the present invention performed on the server machine; and

FIG. 4 illustrates an evaluation table used in the process of FIG. 3.

### DETAILED DESCRIPTION OF THE INVENTION

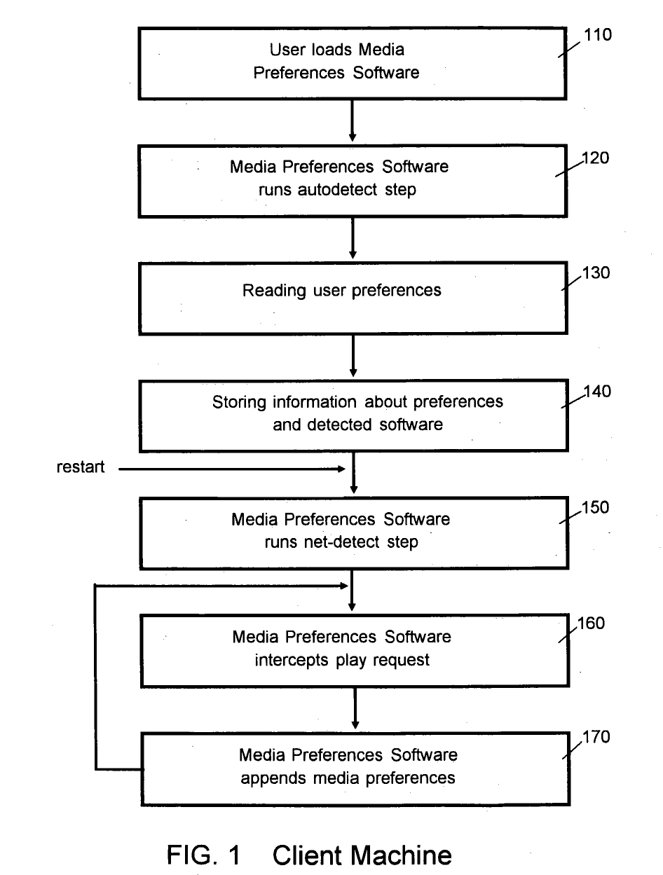

With reference now to FIG. 1, there is depicted a flow chart illustrating the procedure in accordance with the present invention performed on the client machine.

In the first step (block 110) users have to download a particular program product herein called “Media Preferences Software” to their machine running the web browser. After having been downloaded and started, the Media Preferences Software performs an auto-detect procedure as illustrated by block 120. In the auto-detect procedure the Media Preferences Software collects information about the media relevant software currently installed on the user's machine. Using either plug-in-techniques supported by browsers like Netscape Navigator by Netscape Communications Corporation, or querying registry entries via operating system APIs (Application Program Interfaces) may achieve this, whereby a “plug-in” is formed by a file containing data used to alter, enhance, or extend the operation of a parent application program.

In the next step (block 130) the user's preferences are read. In order to express the preferences, the user may enter them using a Graphical User Interface provided by the Media Preferences Software. Information such as the preferred media player software are retrieved and processed by the Media Preferences Software. The selection of preferred media player software may influence the selection of the streaming format for subsequent media streams.

In the following step, the Media Preferences Software stores the user's preferences as well as information about installed media software on the user's machine (block 140). This may be achieved by storing the information within a file on the user's machine.

The next step (block 150) forms a “net-detect step” of the Media Preferences Software, i.e., it is determined which data transfer rate can be expected for a future use of a network connection between the user's machine and a distributed communication system, such as the Internet. The data transfer rate is the amount of digital data that is moved from one place to another in a given time.

The “net-detect-step” (block 150) is processed after each restart of the client machine, since the network connection characteristics, in particular the data transfer rate, could have been changed between the latest connection and the restart of the client's computer. For example, the user may establish a connection via a Local Area Network in the user's office and later the user may connect to the distributed communication system via a phone line at home. In case of a restart of the user's machine, the network settings are actually determined, whereas the rest of the user's media preferences are queried from the media preferences stored during the execution of the previous step illustrated in block 140.

After all media preferences have been collected, the Media Preferences Software intercepts all subsequent requests for media as illustrated in block 160. This can be achieved, e.g., by a combination of Java-script based HTML together with browser plugin-technology as explained with reference to block 120. Alternatively, a HTTP-proxy like software scheme may be used to distinguish between media related HTTP requests and non-media related requests. A HTTP-proxy is a special computer piece of software that acts as an intermediary between the user's machine and the distributed communication system in order to ensure security, administrative control, and caching service.

After the media request has been detected, the Media Preferences Software modifies the detected request by appending the media preferences to the request as illustrated by block 170. Consequently, the modified request is then sent to the respective HTTP-server. It is assumed that the particular server is configured in accordance with the present invention and, therefore, is able to interpret the additional information transmitted with the request.

In this case, the media preferences are taken into account during processing of the request.

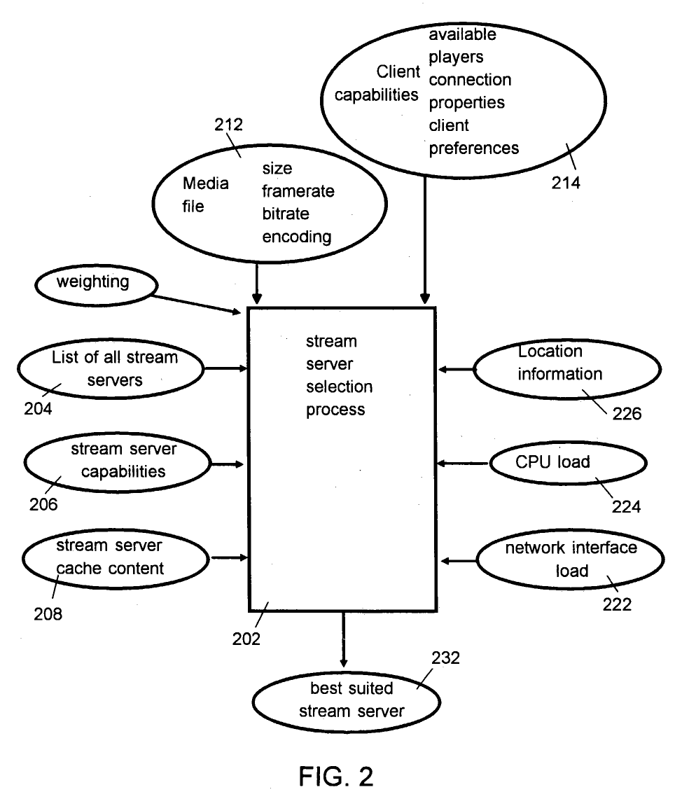

With reference now to FIG. 2, there is depicted a block diagram illustrating the influencing factors on the stream server selection process 202 in accordance to the present invention. The influencing factors are formed by information about all stream servers 204, the stream server capabilities 206, the stream server cache content 208, a media file 212, the client capabilities 214, the network interface load 222, the CPU load 224 and location information 226. All these influencing factors are taken into consideration when determining the best-suited stream server 232.

The list of all stream servers 204 is used to describe the set of stream servers for which the suitability to fulfil the streaming request is evaluated. To each of the stream servers in this list a score is assigned during the selection process, which reflects its suitability in regard to all the influencing factors of the process. The stream server with the highest score is chosen when the selection process is finished.

The stream server capabilities 206 describe the operating parameters of each stream server on the list of stream servers 204. The operating parameters are formed by information about supported media formats, a quality indicator for each format, e.g., “HIGH”, “MEDIUM” or “LOW”.

The media file 212 describes the properties of the file for which a stream server should be selected. The properties are, in particular, the size of the file, the frame-rate for a video to be displayed, the sampling rate and the bit-rate of the content for audio files, the encoding and the format in which the media file is presented.

The client capabilities 214 describe the set of information collected at the client workstation to be used with the stream server selection process. These are, in particular, a list of all available media players at the client's workstation, the quality of connection of the client's workstation, e.g., “LOW”, “MEDIUM”, “HIGH”, the preferences the user at the client workstation has specified, such as the preferred media player.

The following four parameters may optionally be used for further narrowing down the selection, namely the stream server cache content 208, the network interface load 222, the CPU load 224 and location information 226.

The stream server cache content 208 describes for each stream server which media files are already stored in its local cache. The network interface load 222 describes the load of the stream server's network interface in percent of the maximum load. The CPU load 224 describes the load of the stream servers CPUs in percent of the maximum load the stream server hardware can handle and the location information 226 indicates the physical location of the stream servers.

To each of the parameters a “weighting” is assigned, which is, e.g., a number between 0 and 100. This weighting is used to show how important the different factors are compared to each other. As an example: if the clients preferred media player software is more important in the selection process than the capabilities of the stream servers to handle this specific media format, a higher number is assigned to the client preference weighting. This may result in an additional format conversion step, if the media file cannot be rendered by the users preferred media player.

After the weightings are applied to the scores of each stream server, the stream server with the highest score is chosen as the best-suited stream server 232, i.e., the stream server, format, quality triple with the highest score is selected in the end.

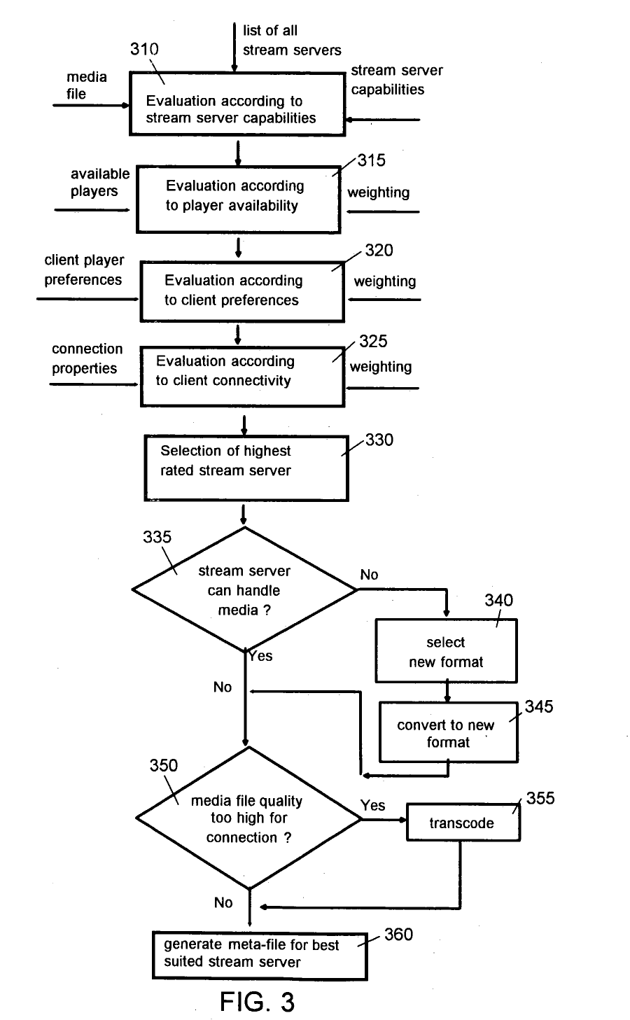

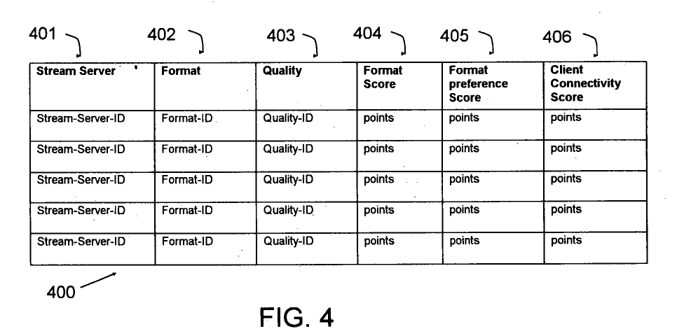

Now with reference to FIG. 3, there is depicted a flow chart illustrating the procedure in accordance with the present invention performed on the server machine for selecting the best suited stream server to provide media streaming in accordance with the user's machine capabilities as previously determined, and with reference to FIG. 4 showing an evaluation table used in the process as illustrated in FIG. 3.

In detail, in the first step (block 310) a list of available stream servers is checked for their capability to handle the media file requested by a client machine. The list of available stream servers may be retrieved from a list provided by an administrator or from a service directory, such as the UDDI (Universal Description, Discovery, and Integration).

Querying the respective stream servers may retrieve the information about the stream servers' capabilities from the list of available stream servers as well or directly.

With this information, the table shown in FIG. 4 is created. The table 400 is formed by six columns 401, 402, 403, 404, 405 and 406, named Stream Server, Format, Quality, Format Score, Format Preference Score and Client Connectivity Score. The table 400 contains one entry for each combination of formats and streaming qualities for each active stream server. The Stream-Server-ID is a unique identifier for a particular stream server; the Format-ID is an identifier for media formats, such as Apple Quicktime and MP3. The Quality-ID is an indicator in which quality a format can be streamed, e.g., “HIGH”, “MEDIUM”, and “LOW”.

The table is used to assign points to each of the entries during the selection process. An entry is also called triple. This check gives higher points to stream servers capable of handling the media file.

In the following step (block 315), the availability of players on the client is applied to the table 400. User-defined weighting defines how many points are assigned to each triple. These weightings allow emphasizing the importance of the different attributes of the client capabilities. The weighting values for each of the evaluation steps may be stored in a configuration file. For example, if the quality/format combination of a stream server can be rendered by one of the media players on the client's workstation, a score of ‘10’ multiplied by the weighting factor is assigned to the format score field of the table. If not, a score of ‘5’ points multiplied by the weighting factor is assigned to the format score field of the table.

Subsequently, points are assigned according to the clients preferences for the different players installed on the client workstation to the format preference score field (block 320). If the format/quality combination of a triple can be rendered by the users' preferred media player, e.g., 10′ point may be assigned, otherwise, if the format/quality combination cannot be rendered, e.g., ‘5’ points may assigned. Weighting is also applied to the assigned points by multiplying with the weighting factor.

In the following step (block 325), the connectivity of the client workstation is evaluated. The clients' quality of connectivity, e.g., “HIGH”, “MEDIUM”, “LOW”, is matched against each triples Quality value. If the values are equal, e.g., ‘10’ points are assigned to the client connectivity field, otherwise, ‘5’ points are assigned. Stream server triples with a quality level higher or lower than the corresponding connectivity, get a lower rating. Weighting is also applied to this value by multiplying the points with the weighting factor.

Subsequently, the stream server triple table entry with the highest score is selected from the table 400 (block 330). Then, it is checked whether the selected stream server is able to handle the media file (335). It may happen that a stream server is not able to handle the media file although it exceeds the other stream servers by having more points from the other scoring steps. This strongly depends on the weighting factors, which were applied.

If the stream server cannot handle the media, another media file type is selected according to the format capabilities of the highest scored stream servers and the selection process is run once again (block 340). The media file is then converted to this selected format (block 345).

It is assumed that the format the media file is converted to can be handled by the stream server. In case, it cannot be assured that the stream server selected in the second pass-thru is able to stream the media file, it may optionally be checked in a separate step (not shown) whether the media file has to be converted to a different format the stream server is able to handle.

Then, it is checked whether or not the quality of the media file is too high for the current connection capabilities of the client (block 350). This may happen due to the nature of the weighting mechanism. If yes, the media file is transcoded to a quality that can be handled by the connection (block 355), i.e., by reducing the frame-rate or down-sampling the audio with standard algorithms.

Finally, a meta file for the stream server with the highest score is generated (block 360 i.e., the stream server best suited for streaming of the media file is selected and the corresponding metafile is generated and transferred to the client workstation.

Other stages of the stream server selection process may handle other streaming relevant selections like locality, workload of the streaming system or cache content. The weighting factors are always used to allow tuning of the selection process to the different factors.

The present invention can be realized in hardware, software, or a combination of hardware and software. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program product in the present context mean any expression, in any language, code or notation, of a set of instructions intended to cause a system having an information processing capability to perform a particular function either directly or after either or both of the following a) conversion to another language, code or notation; b) reproduction in a different material form.

What is claimed is:

1. A method for enhancing streaming operation in a distributed communication system providing communication links between a plurality of stream servers, a client machine requesting a particular media file, and a stream server selection unit, comprising the steps of:
retrieving a list of stream servers,
evaluating the list of stream servers,
selecting one of the stream servers on the list, and
initiating streaming from the selected stream server.

2. The method according to claim 1, wherein the step of retrieving a list of stream servers further comprises the step of getting the list of stream servers from a directory service.

3. The method according to claim 1, wherein the step of evaluating the list of stream servers further includes the step of retrieving and considering the stream server's capabilities.

4. The method according to claim 1, wherein the step of evaluating the list of stream servers further includes the step of retrieving and considering the player availability.

5. The method according to claim 1, wherein the step of evaluating the list of stream servers further includes the step of retrieving and considering preferences from the client.

6. The method according to claim 1, wherein the step of evaluating the list of stream servers further includes the step of retrieving and considering the client connectivity.

7. The method according to claim 1, wherein the step of evaluating the list of stream servers further includes the step of weighting one or more considered parameters.

8. The method according to claim 1, further comprising the step of determining whether or not the stream server can handle streaming of the requested media file.

9. The method according to claim 1, further comprising the step of determining whether or not the format of the media file has changed.

10. The method according to claim 1, further comprising the step of determining whether or not the quality of the media file is to high for the connection from the selected stream server to the client machine.

11. A method for enhancing streaming operation in a distributed communication system providing communication links between a plurality of stream servers, a client machine requesting a particular media file, and a stream server selection unit, comprising the steps of:
detecting the data transfer rate between the client machine and the distributed communication system,
intercepting a request for streaming a media file,
modifying the streaming request by appending preference information for streaming of the requested media file, and
sending the modified streaming request to the stream server selection unit.

12. The method according to claim 11, further comprising the initial step of detecting the capabilities of the client machine.

13. The method according to claim 11, further comprising the step of retrieving preferences predetermined by a user of the client machine.

14. A device for enhancing streaming operation in a distributed communication system providing communication links between a plurality of stream servers, a client machine requesting a particular media file, and a stream server selection unit, the device being configured to perform a method according to claim 1.

15. A computer program product stored on a computer usable medium, comprising computer readable program means for causing a computer to perform a method according to claim 1.
